(19) United States
(12) Patent Application Publication
(10) Pub. No.: US 2014/0288364 A1
(43) Pub. Date: Sep. 25, 2014

(54) OSCILLATING MASSAGE DEVICE WITH INTERCHANGEABLE ATTACHMENT TIPS

(71) Applicant: Tiffany St. Bernard, Ithaca, NY (US)

(72) Inventor: Tiffany St. Bernard, Ithaca, NY (US)

(73) Assignee: LoveMuah, LLC, East Granby, CT (US)

(21) Appl. No.: 14/220,551

(22) Filed: Mar. 20, 2014

Related U.S. Application Data
(60) Provisional application No. 61/803,658, filed on Mar. 20, 2013.

(51) Int. Cl. A61H 19/00; A61H 23/02

(52) U.S. Cl. CPC A61H 19/34; A61H 23/02; A61H 19/44
USPC 600/38; 601/93; 601/48

(57) ABSTRACT

A vibrator unit of a massage device of the present invention has a housing 101 with an upper portion configured to accept a variety of cup head attachments having varying predetermined designs and a jelly cap so as to vary the feel of the vibrator unit. The motor and control circuitry are configured for creating oscillatory vibrations and to utilize the magnetic repulsive force to create random oscillating motion.

### FIELD OF THE INVENTION

The present invention relates to the field of massage devices and, in particular, to an electro-mechanical device with improved oscillating function and feel to the user.

### BACKGROUND OF THE INVENTION

There are numerous devices available to stimulate the erogenous zones of the body including the external and internal genitalia. Devices include manual products that achieve stimulation by variation of size, shape, and texture and vibratory products, commonly referred to as vibrators that achieve stimulation by shape, texture and vibration. In the prior art, vibrators were loud phallic-shaped devices that vibrate in the limited range of 3-5 degrees. Devices with a narrow range of vibration pattern can cause numbing, discomfort and result in the users genitalia becoming inflamed.

Simple vibration is accomplished by internal motors commonly utilize a simple motor and off-centered weight to cause vibration. The control circuitry can be programmable, so as to vary the frequency of the vibration, patterns of on and off, and other patterns. Essentially, conventional motor and control circuitry are linear and present the same pattern, which while pleasurable, reduces the randomness, variation and life-likeness of unexpected movement. As such, they can generally be used to stimulate but over time the pattern can become tiresome and uninteresting to the user.

The applicant is aware of several devices that can be used to stimulate the G-spot, such as that shown in U.S. Patent Publication No. US20060195999 A1. This device is generally a molded plastic cap which is adapted to fit over the bristles of the head of an electric toothbrush. The cap features knob-like protrusions for enhanced stimulation and used to massage the G-spot area. Motion of brush head is in a short radial motion in one direction and then reversed with the cap being adhered to the bristles so as to transfer the motion of the bristles to the cap, thereby insuring transfer of motion between the two parts. Again, this type of device is effective for stimulating, however, the short, rotational motion can become tiresome, repetitive and numbing such that stimulation may occur initially with diminishing effectiveness over time. Other devices similarly utilize standard rotational motors with weights and other means to create motion and vibration.

The present invention seeks to overcome the shortcomings of the prior art by providing an oscillating motion device that is a significant advance over known vibrators. These prior art devices are limited in functionality, oscillation pattern, and lack the ability to exchange attachments. The prior art devices also have disadvantages of being large, bulky, hard to hold, and having a risk of irritation. The present invention seeks to overcome these shortcomings prior art including repetitive motion of prior art motors and controls. The vibrator of the present invention is designed to provide oscillatory vibration unlike the devices of the prior art.

### SUMMARY OF THE INVENTION

It is an object of the present invention to provide an apparatus, system and method of using repulsive force of magnets to provide oscillatory motion that results in random orbital motion and an improved experience.

In one embodiment the vibrator of the present invention utilizes an internal power source energizing a motor connected to one permanent magnet that repulses. The motors can be operated to create oscillatory motion in permanent magnets arranged to utilize the repulsive force resulting in a random orbital vibration in the entire device.

The vibrator of the present invention, moreover, is provided with an internal skeleton of either molded plastic and/or pre-shaped metal (such as a memory alloy) so that use of a very soft silicone body will not result in an appliance that can't hold its shape.

It is an object of the present invention to provide an apparatus, system and method with a larger range of vibratory movement reducing numbing, or making it less likely to occur, thereby resulting in the user reaching multiple orgasms.

It is an object of the present invention to provide an apparatus, system and method of treatment that advantageously can be waterproof, operated in water, for example, used in the bathtub or under the shower where may women preferentially perform self-stimulation, being able to fully submerge the device in water to clean it, and if vaginal dryness is an issue where there is a need to use a water-based lubricant during intercourse or self stimulation.

It is yet another object of the present invention to provide an apparatus, system and method of stimulation that advantageously can be configured as an oscillator or stimulator for direct clitoral stimulation, utilizes a powerful motor, Provides varying ranges of oscillation instead of vibrations, and oscillates in a large range (in a 360 degree circle, up and down, rotationally side to side motion.).

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Description of the Embodiments, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1 illustrates a schematic view of a massage device, system and method according to an embodiment of the present invention;

FIG. 2 illustrates an exploded perspective view of the massage device and base;

FIG. 3 illustrates an exploded front view of the massage device and base;

FIG. 4 illustrates an exploded front view of the massage device and base;

FIG. 5 illustrates a top view of the massage device and base;

FIG. 6 illustrates a bottom view of the massage device and base;

FIG. 7 illustrates a front view of the massage device and base;

FIG. 8 illustrates a rear view of the massage device and base;

FIG. 9 illustrates a side view of the massage device and base, opposite side view being the same;

FIG. 10 illustrates a perspective view of the massage device;

FIG. 11 illustrates a top perspective view of the massage device;

FIG. 12 illustrates a bottom view of the massage device;

FIG. 13 illustrates a bottom perspective view of the massage device;

FIG. 14 illustrates a side view of the massage device, opposite side being the same;

FIG. 15 illustrates a rear view of the base;

FIG. 16 illustrates a schematic view of the massage device and base according to an alternative embodiment of the present invention;

FIGS. 17A, 17B, 17C, 17D, 17E, and 17F illustrate attachment tips of the massage device;

FIG. 18A, 18B, and 18C illustrate schematic view of the massage device according to an alternative embodiment of the present invention;

FIG. 19 illustrates a cross sectional schematic of the oscillating massage device; and

FIG. 20 illustrates an exploded perspective view of the massage device;

FIG. 21 illustrates a schematic, block diagram of the control circuitry of the apparatus, system, and method of the present invention.

### DESCRIPTION OF THE EMBODIMENTS

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “vibrator” refers to a device that vibrates in an oscillating way useful for (1) female stimulation including at least three areas, namely the clitoris and surrounding skin, the inner surface of the vagina and the so-called G-spot area located along the anterior surface inside the vagina, (2) male stimulation of the penis or gland(s), (3) Kegal exercises, and/or (4) sexual therapy.

As used herein the term “therapy” or “sexual therapy” refers to, assuming no physiological problems, orgasmic therapy or other effective ways of treating sexual dysfunction to speed up the process of sexual awareness and acceptance of human functions. For example, studies find that 10% of women are unable to reach orgasm under any condition, where the use of a sexual aid can be helpful in sexual therapy such as, for example, and clitoral stimulation. Kegal exercises are another form of therapy where the use of a sexual aid can be helpful in strengthening physical function and recovery from for example, childbirth and other conditions impacting sexual health. Lastly, clinicians deem sexual aids healthy and consider these as promoting the happiness and empowerment of women.

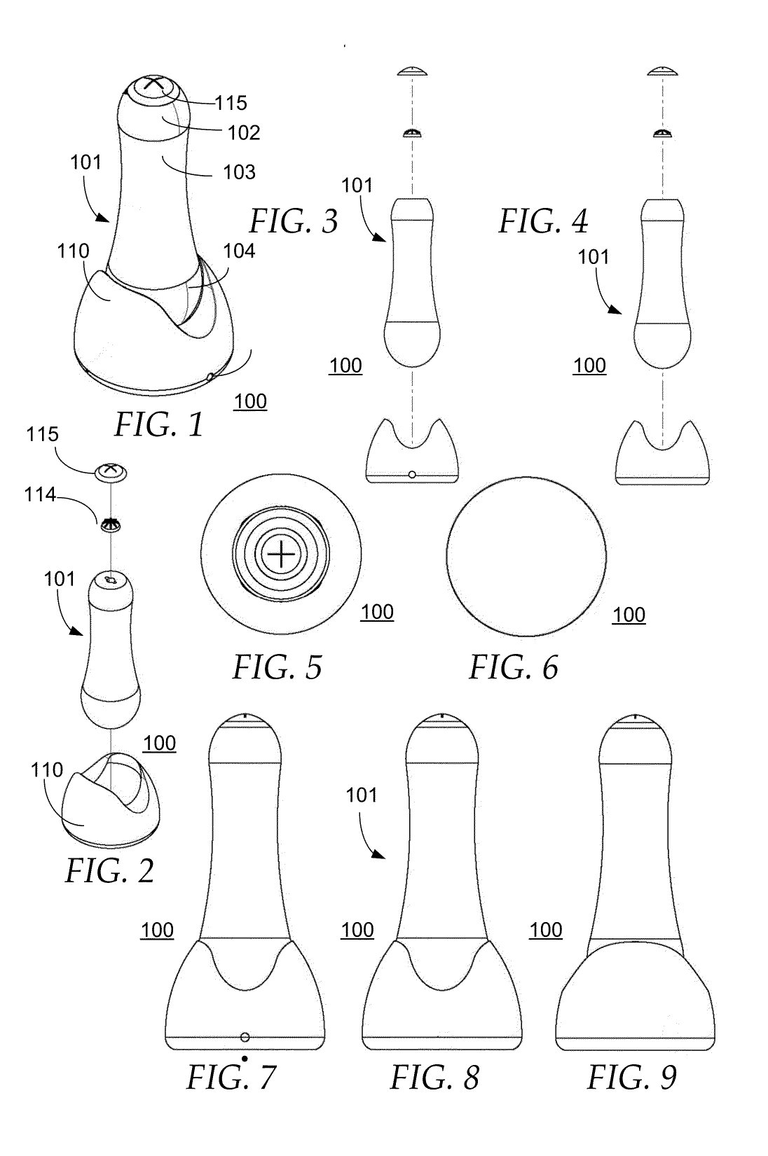

Referring now to FIGS. 1 through 21, the vibrator unit of the massage device of the present invention is generally described as element 100 in according with the various embodiments of the present invention. The vibrator unit 100 has a housing 101 having a generally elongated shape. For ease of describing the housing 101 throughout the description, the housing has a top portion 102, mid-portion 103 and bottom portion 104. The top portion 102 configured to vary the feel using attachment clips and jelly cap. The mid-portion 103 and bottom portion 104 are configured for charging and input control functions.

The housing 101 encompasses a motor 105 and control circuitry 106 configured for creating oscillatory vibrations. The motor 105 functions to create creating oscillatory vibrations in a rotary, linear or oscillatory function. The housing 101 can be configured of plastic or other composite to form a fully waterproof body, for example, the housing 101 has a silicone outer layer, and one of a resilient plastic inner skeleton and a metal inner skeleton

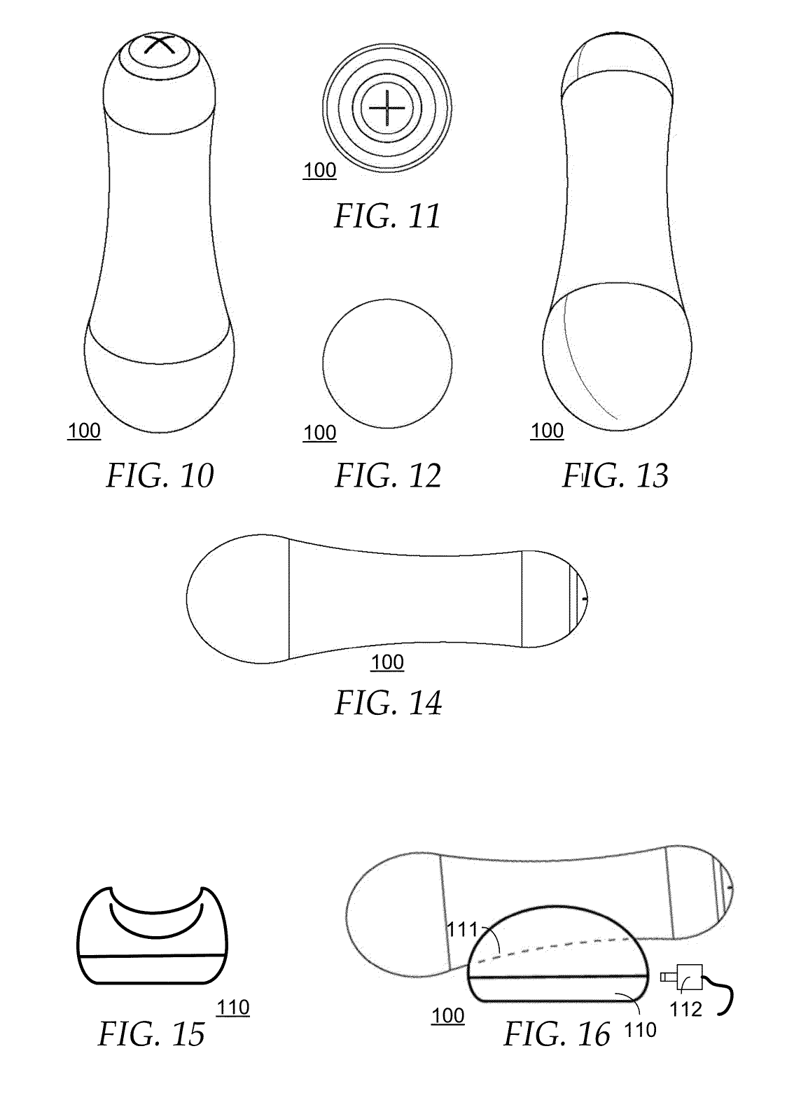

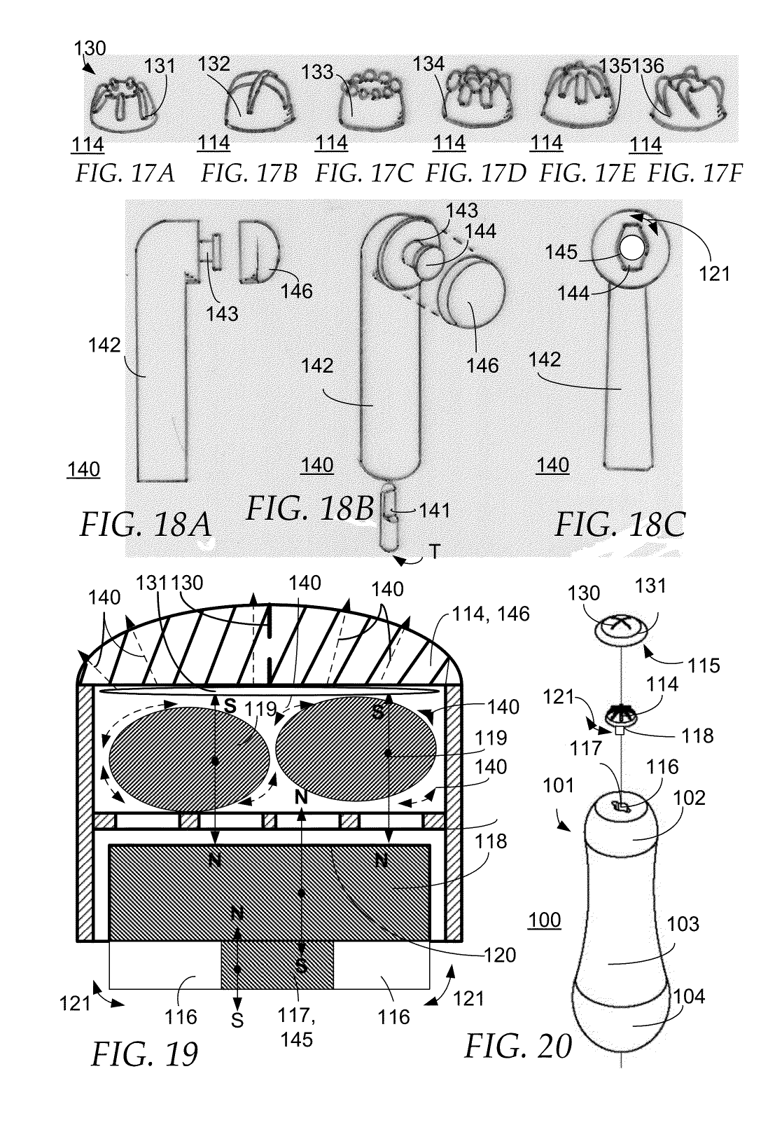

Various views of the vibratory unit 100 design of the unit 100 and its base are shown in FIGS. 1 through 9, and FIGS. 19, 20 and 21. The base can serves as a charger and stand and described herein. Various views of the vibratory unit 100 design are shown in FIGS. 10 through 14 and as described herein. Moreover, various views of the vibratory unit 100 design are shown in FIGS. 17A, 17B, 17C, 17D, 17E, 18A, 18B and 18C and as described herein as an attachment for a rotary toothbrush. FIGS. 19, 20 and 21 describe the operation and control functions of the oscillatory vibrations in the vibrator unit 100 or attachment 104.

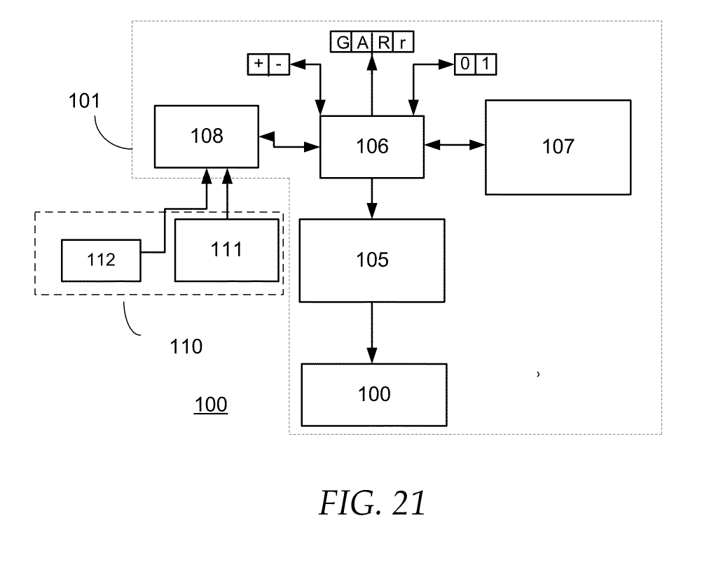

As is illustrated in FIG. 21, the vibrator unit 10 has control circuitry 106 to control various operations of the vibrator unit 100 via a switch means. The switch means can actuate the motor in more than one on mode. The switch means can be a toggle switch, or any electronic switch of dimension and character, to provide operation modes of the vibrator unit 100 are configured for on “1”, off “0”, faster “+” and slower “−”. In an alternative embodiment, the switch means can be can be voice activated, actuated by buttons incorporated into the housing 101 such as in the mid- or bottom portions 103 and 104, respectively, or by actuators or buttons hidden underneath a waterproof skin surrounding the elongated housing in these locations. The control circuitry 106 has a communication circuit 107 for use in the voice activation function of the vibrator unit 100.

The communication circuit 107 can be a Bluetooth communication protocol to allow the user two control the rate and pattern of oscillation with voice commands such as to create oscillating vibrations by the vibrator unit 100 for use during clitoral stimulation or sexual therapy that is controlled via voice commands. For example, the control circuitry 106 can have simple recognition of voice commands to control the speed such as “faster”, “slower”, “hold” “right there” or “stop” stored in memory and programmed to actuate the motor 105 to increase, decrease, hold or stop the oscillatory vibrations of the vibrator unit 100. The user can utilize a Bluetooth microphone available on the marketplace paired with the Bluetooth chipset circuitry of the control circuitry 106. In this manner, the vibrator unit 100 can be made to operate hands free.

The vibrator unit 100 it is configured to have a power source such as a battery 108. The battery 108 is configured to energize the motor 105 and control circuit 106 of the vibrator unit 100. The battery 108 can be a high quality, long-lasting quick to charge lithium-ion battery. The control circuitry 106 can be configured to have a charge indicator 109 providing an indication of the status of the battery 108 such as, for example, an LED adapted to display the following indications: “G”—Green=fully charged; “A” amber=X minutes left; “R” red=dying; and “r” flashing red=almost dead.

The vibrator unit 100 is configured to be rechargeable using a base unit 110 such as for example, powered by any certified source such as an induction charger 111 that allows for fast recharging and avoids dealing with long cords, or a charger port 112 for an AC Adapter, DC or. USB charging input.

Referring specifically to FIGS. 1, 5, 11, 14, 17A-17F, 18A-18C, and 20, according to an embodiment of the oscillator vibrator unit 100, the upper portion 102 of the unit 100 includes cup head 114 and a jelly cap 115 configured to attach over the cup head 114 so as to portray the general shape of the cup head 114 into a softer feel to the user. The cup head 114 can be attached to a port key 116 located in or protruding from the upper portion 102 of housing 101, or in alternative embodiments as elements 142, 143 as shown in FIGS. 18A, 18B, and 18C.

The port key 116 connects to the motor 105 of the base housing 101. The port key 116 The vibrator unit 101 is configured with a magnetic attachment means to secure the port key 116 formed from using the attractive forces of a port magnet 117 in the upper end housing 101 and a head magnet 118 located in the cup head 114. Joining the attractive forces of the magnets 117 and 118 means arranging the opposite poles to attract each other, for example, N-pole of the port magnet 117 arranged adjacent S-Pole of head magnet 118 in the cup head 114. In this manner the attachment means allows for exchangeable attachments of various cup heads, such as predetermined designs 130 and 131-136 as shown in FIGS. 17A-17F, 19 and 20, which join cup head 114, 130 via port key 116 to the housing 101. The vibrator unit 100 improves the feel and user experience as the cup head 114 attachment is covered by a removable jelly cap 115 as shown in FIG. 20. The interchangeable cup head 114 functions to change the texture and or shape of the upper portion 102 and is useful in therapy such as (1) female stimulation including at least three areas, namely the clitoris and surrounding skin, the inner surface of the vagina and the so-called G-spot area located along the anterior surface inside the vagina, (2) male stimulation of the penis or gland(s), (3) Kegal exercises, and/or (4) sexual therapy. The jelly cap 115 material is configured to be thin enough so that the user can also feel the texture and shape of the cup head 114.

As is illustrated in FIGS. 17A, 17B, 17C, 17D, 17E, and 17F, various predetermined surface texture designs 130 can be formed in the cup head 114. The vibrator unit 100 has the advantages by combining one of the predetermined surface texture designs 130 and a jelly cap 115 to allow for an endless variety of textures, shapes and feels. For example, as is illustrated in FIG. 17A, a bunt-shape protrusion 131 is formed in the cup head 114 as a predetermined design 130. Referring to FIG. 17B, a cross-shaped protrusion 132 is formed in the cup head 114 as a predetermined design 130. As is illustrated in FIG. 17C, a pearl-necklace-shaped protrusion 133 is formed in the cup head 114 as a predetermined design 130. Referring to FIG. 17D, a globing-shaped protrusion 134 is formed in the cup head 114 as a predetermined design 130. As is shown in FIG. 17E, a lava-flow-shaped protrusion 135 is formed in the cup head 114 as a predetermined design 130. Finally, referring to FIG. 17F, a swirl-shaped protrusion 136 is formed in the cup head 114 as a predetermined design 130. Other variations of the predetermined design 130 are possible so as to provide advantageously increasing sensual power and a wider range of vibration as compared to the feel to the user from prior art devices by the present invention varying texture and shape of the cup head 114 and felt through the improve jelly cap 115.

As is illustrated in FIGS. 18A, 18B, and 18C, an attachment 140 is configured and adapted for a toothbrush (T) to provide improved oscillatory motion according to an alternative embodiment of the present invention. As is illustrated in FIG. 18A, the attachment 140 has an elongated shaft portion 142 adapted to receive the rotating shaft 141 of a toothbrush T. An upper end 143 is connected to the shaft 141 and translates the rotation of shaft 141 to the upper end 143, for example, rotating it repeatedly back and forth between 3-5 degrees. The upper end 143 has an outwardly extending port key 144 configured with a magnet 145. The magnet 145 is arranged to form a magnetic attachment the cap or head 146, for example, head magnet 118 as shown in FIG. 19. The cap 146 is received on the outwardly extending port key 144 as is shown in FIGS. 18A, 18B and 18C. In this manner, a vibrator unit 100 has advantages to interchange various predetermined surface texture designs 130 and, as shown in FIG. 19, an oscillating motion 140 created by the magnetic repulsive force of one or more oscillatory magnets 119.

According to an embodiment of the present invention, oscillating motion can be formed in the cup head 114. As is shown in FIG. 19, more random orbital oscillating motion creates more sensation so as to provide a wider range of vibration of the vibrator unit 100. The oscillating motion 140 is created by the magnetic repulsive force of one or more oscillatory magnets 119 located in the cup head 114 resulting in a more random orbital motion for more sensation in therapy. First, the cup head 114 attaches a port magnet 117 of the attachment means .e.g. the head magnet 118 of the port key 116 by aligning the opposite poles of the permanent magnet such that the attractive force provides a secure connection between the port magnet 117 and head magnet 118 of the attachment means, e.g. arranging N-S to N-S.

Once attached by the attachment means, the motor 105 is directly connected and imparts motion 121 to the cup head 114 and the one or more oscillatory magnets 119, as shown in FIGS. 18C, 19 and 20. When the vibrator unit 100 is powered on (“1”), depending on the motor 105 function as the motion 121 oscillates in a side-to-side, semi-circular, circular or liner monition. The oscillation or linear pattern can be customized to the users preference using an online program downloaded to the control circuitry 106. It is to be appreciated that a random oscillatory motion is imparted to the oscillatory magnets 119 using the repulsive forces between head magnet 118 and the one or more oscillatory magnets 119, e.g. utilizing the opposite polarity of an upper surface 120 of the magnet 121 of the attachment means, as shown in FIG. 19.

As illustrated in FIG. 19, Random repulsive forces are imparted to the one or more magnets 141 located in a compartment in the cup head 114 because of the motion of the motor 105 imparting on the port key 116, or as shown in FIG. 18 the shaft 141 of a toothbrush T. The motion of the repulsive force creates oscillating in the surface of the cap 114 and jelly cap 115. As a result, the vibrator unit 100 can provide oscillating motion in a wide range of vibrations for use during clitoral stimulation or sexual therapy and also can be controlled via voice commands. The vibratory unit 100 has a unique oscillation patterns including twisting from side to side or in a linear pattern with random oscillating motion imparted throughout the cycle.

The present invention utilizes a feature of a micropore attachment 130 similar to the jelly cap 115. The micropore attachment 130 has a reservoir 131 for lubricant and a porous material or micropore membrane configured in the jelly cap 115 material so as to accept and hold a gel or lubricant adjacent a micropore membrane such that the lubricant flows by pressure through the membrane during intercourse or stimulation. Alternatively, the micropore attachment allows viscous, heat activate lubricants and/or stimulating gels to be slowly released through its pores when warmed up by the users body heat. Micropore attachment 130 is similar to, and can replaced the jelly cap 116, as it has micropores covering its surface to allow lubricants and stimulating gels stored adjacent in an reservoir 131. The user can fill the reservoir 131 with the desired lubricant and/or stimulating gel. In this manner, the micropore attachment 130 advantageously eliminates the need for reapplying lubricant during the sexual session. Eliminating the need for reapplying lubricant is an improvement, and is a disadvantage in the prior art, as prior art has lubricant dispensers separate from the vibrator unit or genital stimulator requiring the user to constantly reapply lubricant throughout their self stimulation experience resulting in interruptions. Interruption can inhibit intercourse or self stimulation resulting in frustration or non-orgasm.

While certain configurations of structures have been illustrated for the purposes of presenting the basic structures of the present invention, one of ordinary skill in the art will appreciate that other variations are possible which would still fall within the scope of the appended claims. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A device for use by for sexual stimulation exercises comprising
A motor disposed in a housing dimensioned for insertion into a vagina, to contact the wall of the vagina at or near the G-spot, the housing having an upper portion configured with a an attachment means for securing a cup head to the upper portion, said cup head configured for transmitting motion from the motor to oscillatory motion in the cup head utilizing the motion of the motor and a repulsive force of oscillatory magnet.

2. The device of claim 1, wherein said repulsive force of is generated by moving a head magnet in said cup head coupled by the attachment means to the motor motion and disposing said oscillatory magnets arranged in a repulsive polar position adjacent an upper surface of the head magnet so as to utilize the motion of the motor.

3. The device of claim 1, wherein said oscillatory magnets are one or more oscillatory magnets.

4. The device of claim 1, wherein said device is provided with a resilient jelly cap to cover the cup head with a soft, pliable outer layer.

5. The device of claim 4, wherein said jelly cap is a micropore attachment with a reservoir for one of the following group of lubricant, gel, stimulating substances disposed in oil, lubricant, gel, and heat activated lubricants and gels.

6. The device of claim 5, wherein said micropore attachment dispenses lubricant in contact with user's body or by the user's body heat.

7. The device of claim 1, wherein the housing is provided with one of a vibratory motor, an electro-stimulation and a mechanical movement.

8. The device of claim 7, wherein said device is provided with power means.

9. The device of claim 8, wherein said power means is one of a rechargeable battery, replaceable battery and wire.

10. The device of claim 9, wherein said rechargeable battery is located in said housing.

11. The device of claim 10, wherein control circuitry disposed in a base unit or said housing includes a recharging circuit for recharging said battery.

12. The device of claim 8, wherein a switch means is provided to turn on or off power to energize the device.

13. The device of claim 12, wherein said switch means is capable of actuating said motors in more than one on mode.

14. The device of claim 1, wherein said device has a silicone outer layer, and one of a resilient plastic inner skeleton and a metal inner skeleton.
